(19) United States
(12) Patent Application Publication
(10) Pub. No.: US 2019/0209417 A1
(43) Pub. Date: Jul. 11, 2019

(54) WALKING AID FOR PETS WITH LIMB INJURY

(71) Applicant: HUI CHU LAICHENG, Taichung (TW)

(72) Inventor: HUI CHU LAICHENG, Taichung (TW)

(21) Appl. No.: 15/863,308

(22) Filed: Jan. 5, 2018

(51) Int. Cl. A61H 3/04; A61D 3/00

(52) U.S. Cl. CPC A61H 3/04; A61H 2003/007; A61D 3/00

(57) ABSTRACT

A walking aid for pets includes a main member, two wheels, and a fastening device. The main member has a closed portion and two wall portions connected to opposite sides of the closed portion, wherein the closed portion and the wall portions enclose a receiving room, and an opening is formed between the wall portions. The wheels are pivoted on the main member. The fastening device is connected to the main member to be worn on a pet.

### BACKGROUND OF THE INVENTION

### 1. Technical Field

The present invention relates to an appliance for pets, and more particularly to a walking aid for pets with limb injury.

### 2. Description of Related Art

Pets having limb injury (forelimbs or hindlimbs) need a wheelchair-like walking aid to help them to walk.

Taiwan utility model no. M549057 provides a conventional wheelchair for pets, which includes a frame and a fastening device. The frame is adapted to hold hindlimbs of a pet, which is provided with an adjusting rod to adjust a length thereof for various sizes of pets. The frame also is provided with two wheels. The fastening device is provided on the frame to fasten the pet on the frame. The fastening device includes two rings to hold the hindlimbs of the pet. This wheelchair does not provide any device to hold an abdomen of the pet.

U.S. Pat. No. 9,179,646 provides a walking aid for disabled four-legged animals, which includes a resting mechanism and a frontal section and a rear section connected together by a pivoting mechanism. The frontal and the rear sections and the resting mechanism are adapted to hole the whole body of a pet, so that the pet could walk by itself through wheels on a bottom of the resting mechanism. This walking aid provides a complex structure.

### BRIEF SUMMARY OF THE INVENTION

In view of the above, the primary objective of the present invention is to provide a waling aid for pets, which provides the pet a sufficient and comfortable support.

The secondary objective of the present invention is to provide a waling aid for pets, which has a simple structure.

In order to achieve the objective of the present invention, a walking aid for pets includes a main member having a closed portion and two wall portions connected to opposite sides of the closed portion, wherein the closed portion and the wall portions enclose a receiving room, and an opening is formed between the wall portions; two wheels pivoted on the main member; and a fastening device connected to the main member to be worn on a pet.

The walking aid of the present invention has a simple structure, and furthermore, it provides a soft pad member to hold the pet to increase the support to the pet.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a first preferred embodiment of the present invention;

FIG. 2 is a top view of the first preferred embodiment of the present invention;

FIG. 3 is a perspective view of the first preferred embodiment of the present invention, showing the walking aid holding hindlimbs of the dog;

FIG. 4 is a top view of the first preferred embodiment of the present invention, showing the adjustment of the fastening device;

FIG. 5 is a perspective view of the first preferred embodiment of the present invention, showing the walking aid holding forelimbs of the dog;

FIG. 6 is a top view of a second preferred embodiment of the present invention.

### DETAILED DESCRIPTION OF THE INVENTION

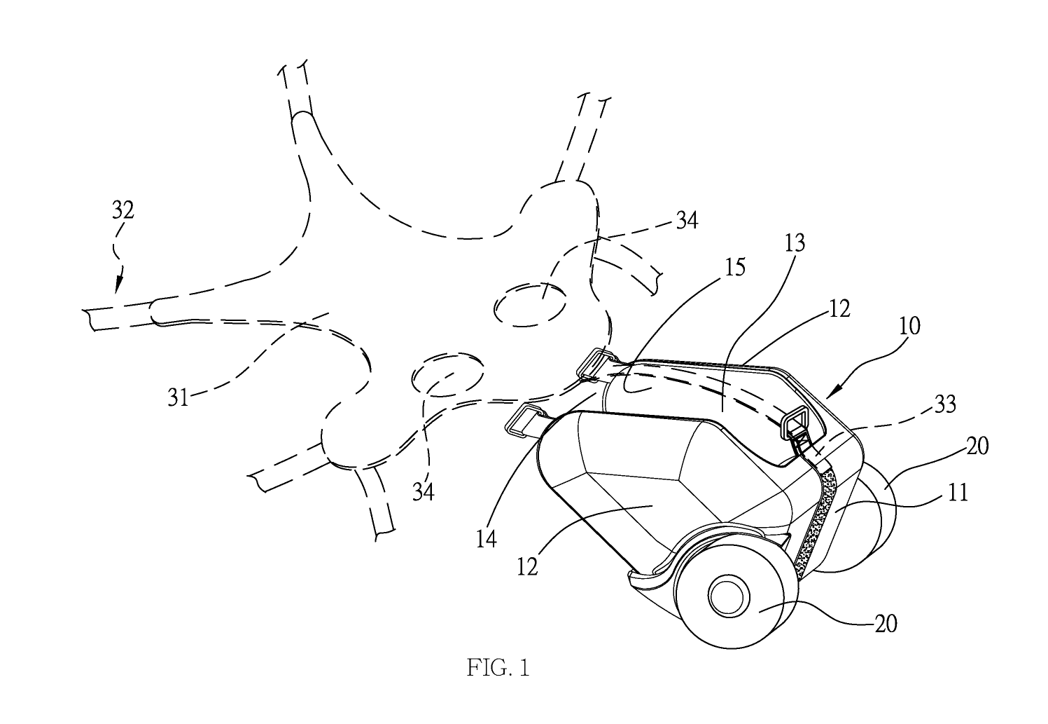

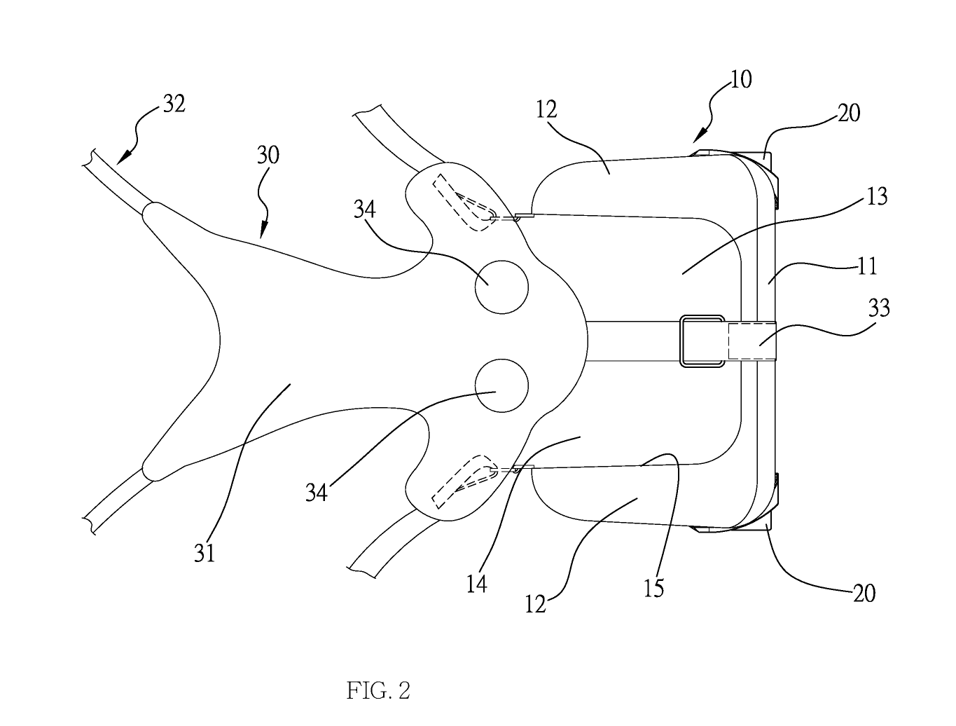

As shown in FIGS. 1 and 2, a walking aid for pets of the first preferred embodiment of the present invention includes a main member 10, two wheels 20, and a fastening device 30.

The main member 10 is a U-shaped member, having a closed portion 11 at a side thereof and two wall portions 12 at opposite sides of the closed portion 11. The wall portions 12 extend in oblique directions, so that there is an included angle between each wall portion 12 and the closed portion 11. The closed portion 11 and the wall portions 12 enclose a receiving room 13, and an opening 14 is formed between the wall portions 12 to be an entrance of the receiving room 13. Each of the wall portions 12 have a concave interior side 15.

The wheels 20 are pivoted on the main member 10 for free rotation. In the present embodiment, the wheels are pivoted at junctions of the closed portion 11 and the wall portions 12, respectively.

The fastening device 30 is made of a flexible fabric to hold a pet. The fastening device 30 has a pad member 31, a fastening member 32, and an adjusting member 33. The pad member 31 is connected to the main member 10 through the adjusting member 33, and has a portion thereof received in the receiving room 13. The fastening member 32 has a plurality of belts connected to opposite sides of the pad member 31. The adjusting member 33 is a belt having opposite ends connected to the closed portion 11 of the main member 10 and the pad member 31. In the present embodiment, the adjusting member 33 is detachably connected to the closed portion 11 of the main member 10 by a clip or a Velcro fastener (not shown). The adjusting member 33 is a conventional adjusting belt which could adjust a length thereof. The pad member 31 is provided with two bores 34.

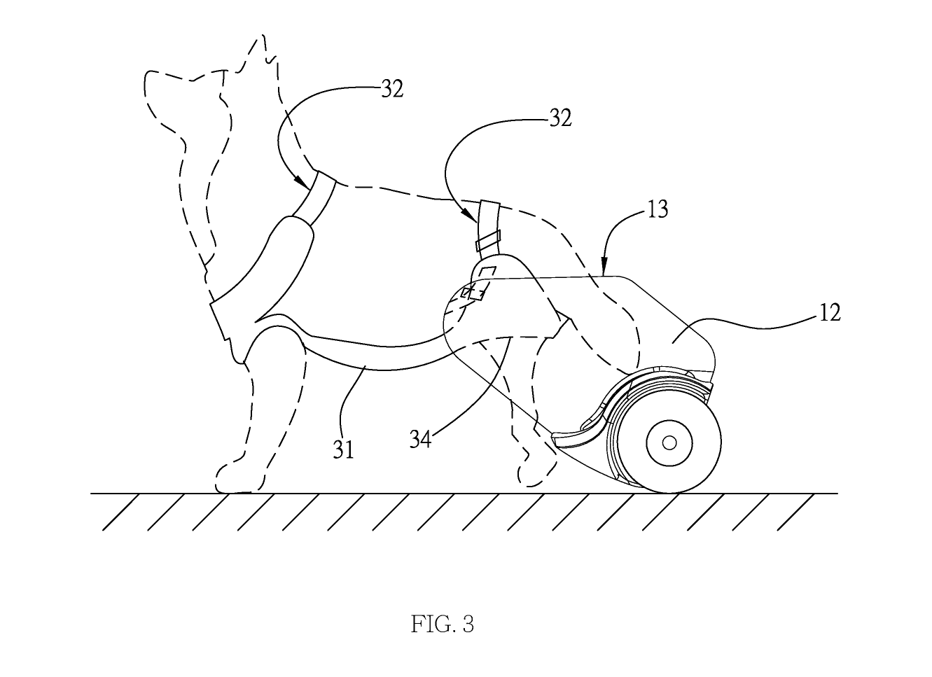

FIG. 3 shows a dog with injured hindlimbs using the walking aid of the present invention. Pass the hindlimbs of the dog through the bores 34 of the pad member 31, and fasten the belts of the fastening member 32 to wear the pad member 31 on the dog. At this time, a rear portion of the dog is received in the receiving room 13 of the main member 10, and the wall portions 12 cover opposite sides of the dog. It would hold the dog and protect the hindlimbs. The pad member 11 covers an abdomen of the dog to support a weight of the dog and reduce the loading of the injured hindlimbs.

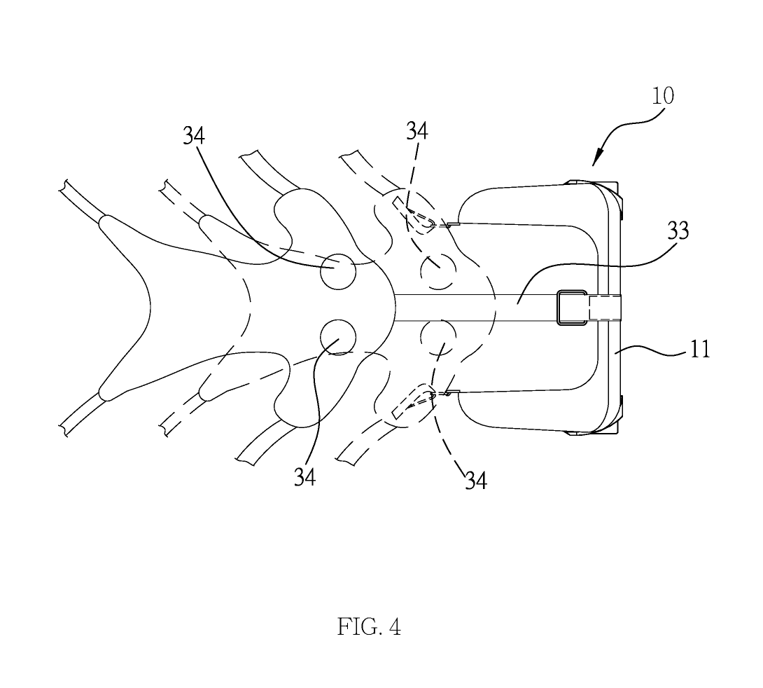

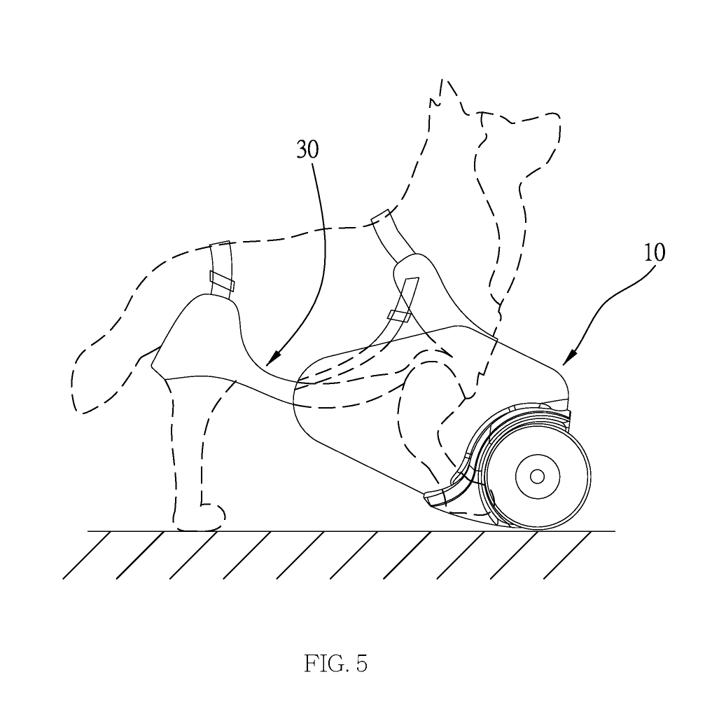

FIG. 4 and FIG. 5 show a dog with injured forelimbs using the walking aid of the present invention. First of all, the adjusting member 33 is elongated to move the pad member 31 away from the member 10 to a predetermined position according to a size of the dog. And then, passing the forelimbs through the bores 34 of the pad member 31, and fasten the belts of the fastening member 32 to wear the pad member 31 on the dog. At this time, a front portion of the dog, including the forelimb, is received in the receiving room 13 of the main member 10, and the wall portions 12 cover opposite sides of the dog. A head of the dog is raised via the opening 14. It would hold the dog and protect the forelimbs. The pad member 11 covers an abdomen of the dog to support a weight of the dog and reduce the loading of the injured forelimbs.

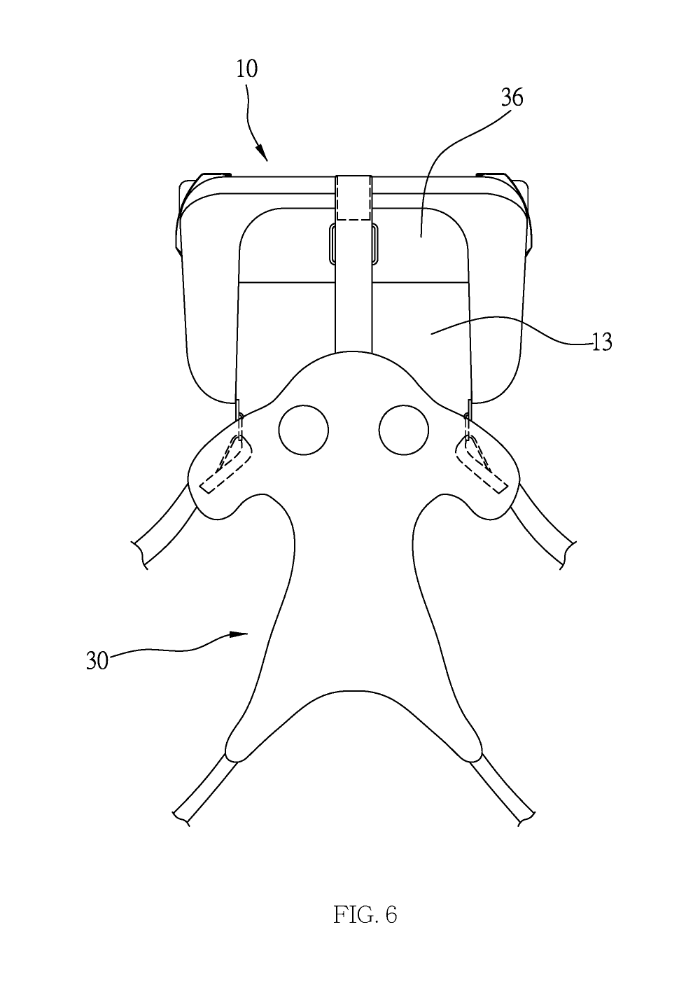

FIG. 6 shows a walking aid for pets of the second preferred embodiment of the present invention, which is the same as the walking aid of the first preferred embodiment, except that the main member 10 has an extending portion 36 projected from a bottom end of the closed portion 11 and between the wall portions 12. The extending portion 36 is at a bottom of the receiving room 13 so that a pet could rest its injured limbs thereon.

In conclusion, the walking aids of the present invention could stably hold the injured limbs of the pet and help the pet to walk by itself. The adjusting member 33 is operated to change a distance between the pad member 31 and the main member 10 according to the size of the pet. The pad member is made of a soft fabric to stably hold the abdomen of the pet.

It must be pointed out that the embodiments described above are only some preferred embodiments of the present invention. All equivalent structures which employ the concepts disclosed in this specification and the appended claims should fall within the scope of the present invention.

What is claimed is:

1. A walking aid for pets, comprising:
a main member having a closed portion and two wall portions connected to opposite sides of the closed portion, wherein the closed portion and the wall portions enclose a receiving room, and an opening is formed between the wall portions;
two wheels pivoted on the main member; and
a fastening device connected to the main member to be worn on a pet.

2. The walking aid of claim 1, wherein the fastening device includes a pad member, a fastening member connected to the pad member, and an adjusting member having an end connected to the pad member and an opposite end detachably connected to the main member.

3. The walking aid of claim 2, wherein the fastening member includes a plurality of belts connected to opposite sides of the pad member to be fastened to each other to fasten the pad member to the pet.

4. The walking aid of claim 2, wherein the pad member is provided with two bores to pass limbs of the pet therethrough.

5. The walking aid of claim 1, wherein the main member has a concave interior side.

6. The walking aid of claim 1, wherein the main member further has an extending portion at a bottom of the receiving room.
